(19) United States
(12) Patent Application Publication
(10) Pub. No.: US 2014/0182176 A1
(43) Pub. Date: Jul. 3, 2014

(54) ILLUMINATED DISPLAY

(71) Applicant: Valerie Lynn Kaleugher, Sewickley, PA (US)

(72) Inventor: Valerie Lynn Kaleugher, Sewickley, PA (US)

(21) Appl. No.: 14/146,602

(22) Filed: Jan. 2, 2014

Related U.S. Application Data
(60) Provisional application No. 61/748,203, filed on Jan. 2, 2013.

(51) Int. Cl. G09F 9/00; G09F 13/04

(52) U.S. Cl. CPC G09F 9/00; G09F 13/04
USPC 40/490; 40/489

(57) ABSTRACT

An illuminated display that may display a decorative translucent placard from a window of a house or building is provided. The illuminated display may include a front portion with a sign holder and a plurality of lights configured to project a light on a sign when the sign is within the sign holder. The illuminated display may further include a slot configured to store additional signs. Therefore, a user may display one sign from the sign holder and then change the sign to display another sign when desired.

### CROSS-REFERENCE TO RELATED APPLICATION

This application claims the benefit of priority of U.S. provisional application No. 61/748,203, filed Jan. 2, 2013, the contents of which are herein incorporated by reference.

### BACKGROUND OF THE INVENTION

The present invention relates to a display and, more particularly, to an illuminated display for holiday decorations.

Currently, people enjoy decorating their house for the holidays. However, some of the decorations are dangerous to setup because they require the user to climb on the roof. Further, it is typical that the decorations are left up throughout the year since the decorations may be difficult and dangerous to take down.

As can be seen, there is a need for a device that includes interchangeable decorations.

### SUMMARY OF THE INVENTION

In one aspect of the present invention, an illuminated display comprises: a front wall comprising a front surface and a back surface; a sign holder protruding from the front surface of the front wall so that a space is formed in between the front surface and a sign when a sign is supported by the sign holder; a rear wall joined together with the front wall by a bottom support, wherein a storage slot is formed in between the rear wall and the front wall formed to receive a plurality of signs; and a plurality of lights attached to the front surface of the front wall configured to be behind the sign when the sign in supported by the sign holder.

In another aspect of the present invention, a method of displaying a display from a window comprises: providing an illuminated display comprising: a front portion comprising a sign holder and a surface behind the sign holder comprising a plurality of lights; and a rear portion comprising a slot; installing the illuminated display on a window; placing a translucent display placard within the sign holder to be displayed; and turning on the lights and thereby illuminating the translucent display placard.

These and other features, aspects and advantages of the present invention will become better understood with reference to the following drawings, description and claims.

### BRIEF DESCRIPTION OF THE DRAWINGS

FIG. 1 is a front perspective view of the present invention;

FIG. 2 is a cross-sectional view taken on line 2-2 of FIG. 1;

FIG. 3 is a front exploded perspective view; and

FIG. 4 is a rear exploded perspective view.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an illuminated display that may display a decorative translucent placard from a window of a house or building. The illuminated display may include a front portion with a sign holder and a plurality of lights configured to project a light on a sign when the sign is within the sign holder. The illuminated display may further include a slot configured to store additional signs. Therefore, a user may display one sign from the sign holder and then change the sign to display another sign when desired.

The present invention includes a unit that holds light emitting diode (LED) lights to a backlight event specific artwork duratrans that may adjust to fit into the inside of a homeowner's window. The present invention eliminates the need to store holiday decorations that are not in use and eliminates the need to climb ladders to decorate the outside of the house. The present invention may include a convenient storage slot for unused artwork. The present invention may be placed on the inside of the window and decorates the home, with easily interchangeable duratrans.

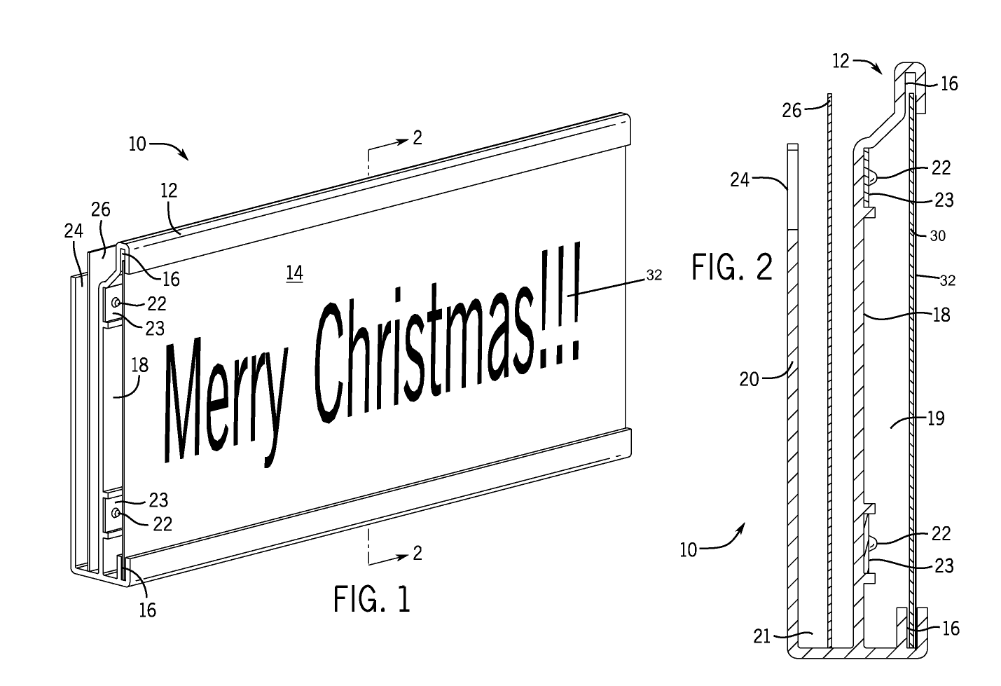

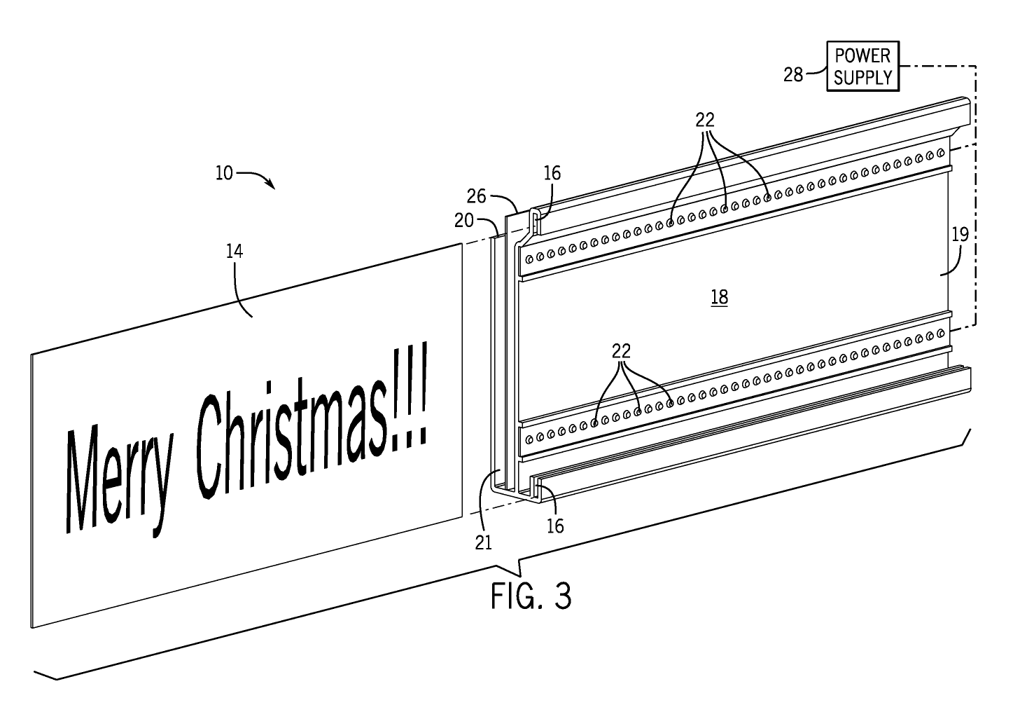

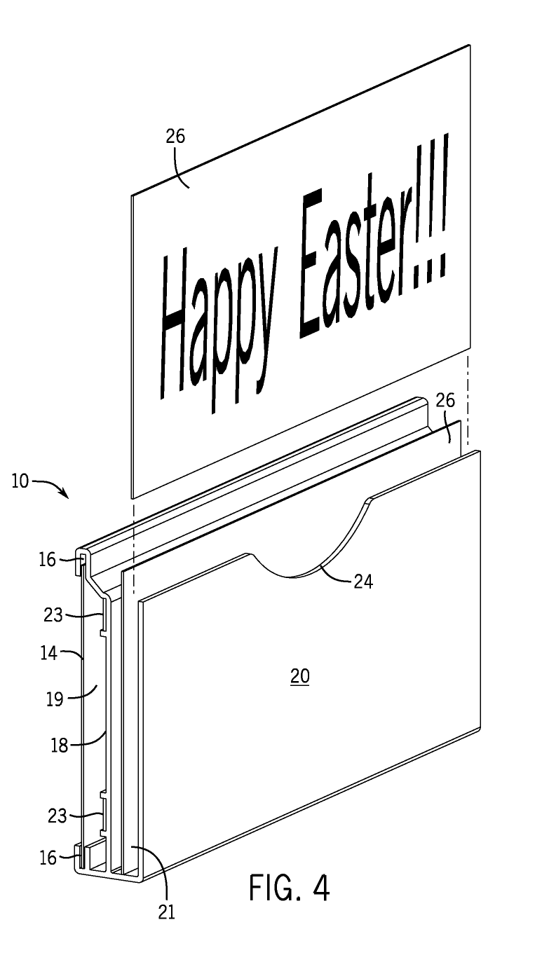

Referring to FIGS. 1 through 4, the present invention includes an illuminated display 10. The illuminated display 10 may include a front wall 18 having a front surface and a back surface. A sign holder 12 may protrude from the front surface of the front wall 18. A space 19 may be formed in between the front surface and the sign 14 when the sign 14 is supported by the sign holder 12. The present invention may further include a plurality of lights 22 attached to the front surface of the front wall 18. The lights 22 may be behind and therefore may shine light through the sign 14. The lights 22 may be connected to power supply 28. In certain embodiments, the power supply 28 may be solar power.

In certain embodiments, the present invention may include a rear wall 20 joined together with the front wall 18 by a bottom support. A storage slot 21 is formed in between the rear wall 20 and the front wall 18. The storage slot 21 may be formed to store a plurality of signs 26. Therefore, when the user would like to change out the sign 14 that is within the sigh holder 12, the user may easily grab a sign 26 from the storage slot 21 and replace the sign 14 that was within the sign holder 12. In certain embodiments, the rear wall may include a cutout portion 24 so that a user may easily grasp an additional sign 26.

In certain embodiments, the sign holder 12 may include an upper extrusion and a lower extrusion protruding from the front surface of the front wall 18. A channel 16 may be formed in the upper extrusion and the lower extrusion. The channels 16 formed within the extrusions may face one another. Therefore, the edges of a sign 14 may be easily slid into and out from the channels 16 so that the extrusions may support the sign 14 within the sign holder 12.

As illustrated in the Figures, the plurality of lights 22 may include a line of lights running across the top end and the bottom end of the front surface of the front wall 18. The line of lights 22 may be attached to strips 23. In certain embodiments the lights 22 may be LEDs. However, the lights 22 are not limited to LEDs and may be any type of light desired. The sign 14 may include a translucent display placard 32 so that the light from the LEDs may easily shine through the signs 14. The sign 14 may further include at least one plastic diffusion sheet 30. The diffusion sheet 30 may disperse the heat from the LEDs. The plastic diffusion sheet 30 may be connected with or separate from the translucent display placard 32. The diffusion sheet 30 may rest in between the display placard 32 and the LEDs, within the sign holder 12. In certain embodiments, the signs 14 may include messages, such as “Merry Christmas” or “Happy Easter.” Therefore, when the season has changed, the user may easily switch out the sign 14 for the alternative sign 26 within the slot 26.

A method of displaying a display from a window comprises: providing an illuminated display comprising: a front portion comprising a sign holder and a surface behind the sign holder comprising a plurality of lights; and a rear portion comprising a slot; installing the illuminated display on a window; placing a translucent display placard within the sign holder to be displayed; and turning on the lights and thereby illuminating the translucent display placard. The method may further include: removing the translucent display placard from the sign holder; retrieving a second translucent display placard from the slot; and placing the second translucent display placard within the sign holder.

The present invention may include an extruded plastic piece that adjusts to different window widths. The present invention may include tracks to fit duratrans artwork sheet and one plastic diffusion sheet. The present invention may use the sheet of LED's connected to a power supply, the translucent artwork sheets and their storage slot and the expandable unit itself that holds the above components into the window. In alternative embodiments, solar power may be used to light the LEDs. The individual components of the unit work together to hold plastic artwork sheets and illuminate them with low heat/consumption LED lights. The homeowner would use this unit to safely and conveniently store event specific decorations.

It should be understood, of course, that the foregoing relates to exemplary embodiments of the invention and that modifications may be made without departing from the spirit and scope of the invention as set forth in the following claims.

What is claimed is:

1. An illuminated display comprising:
a front wall comprising a front surface and a back surface;
a sign holder protruding from the front surface of the front wall so that a space is formed in between the front surface and a sign when a sign is supported by the sign holder;
a rear wall joined together with the front wall by a bottom support, wherein a storage slot is formed in between the rear wall and the front wall formed to receive a plurality of signs; and
a plurality of lights attached to the front surface of the front wall configured to be behind the sign when the sign in supported by the sign holder.

2. The illuminated display of claim 1, wherein the sign holder comprises an upper extrusion and a lower extrusion, wherein the upper and lower extrusions comprise grooves formed to receive the edges of the sign.

3. The illuminated display of claim 1, further comprising the sign, wherein the sign comprises a translucent display card.

4. The illuminated display of claim 1, further comprising a plurality of different signs stored in the storage slot.

5. The illuminated display of claim 1, wherein the plurality of lights comprise a line of lights running across the front surface near a top end of the front wall and a line of lights running across the front surface near a bottom end of the front wall.

6. A method of displaying a display from a window comprising:
providing an illuminated display comprising: a front portion comprising a sign holder and a surface behind the sign holder comprising a plurality of lights; and a rear portion comprising a slot;
installing the illuminated display on a window;
placing a translucent display placard within the sign holder to be displayed; and
turning on the lights and thereby illuminating the translucent display placard.

7. The method of claim 6, further comprising the steps of:
removing the translucent display placard from the sign holder;
retrieving a second translucent display placard from the slot; and
placing the second translucent display placard within the sign holder.
